(19) United States
(12) Patent Application Publication
(10) Pub. No.: US 2007/0130374 A1
(43) Pub. Date: Jun. 7, 2007

(54) Multiported memory with configurable ports

(75) Inventors: Kuljit S. Bains, Olympia, WA (US); John B. Halbert, Beaverton, OR (US); Randy B. Osborne, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/280,837

(22) Filed: Nov. 15, 2005

(51) Int. Cl. G06F 3/00

(52) U.S. Cl. 710/8

(57) ABSTRACT

In some embodiments, a chip includes memory banks and data ports, including at least first and second data ports, coupled to the memory banks. The chip also includes control circuitry to control a configuration of the first data port to be in one of multiple configurations in response to a configuration command, wherein the available configurations for the first data port include at least two of the following: whether the first data port (1) may only be used for read transactions, (2) may only be used for write transactions, or (3) may be used for either read or write transactions while in the configuration. Other embodiments are described.

### BACKGROUND

1. Technical Field

The present inventions relate to multiported memories with configurable ports and to systems that include such memories.

2. Background Art

Various arrangements for memory chips in a memory system have been proposed. For example, in a traditional synchronous dynamic random access memory (DRAM) system, memory chips communicate data through bidirectional data buses and receive commands and addresses through command and addresses buses. In some implementations, the memory chips have stubs that connect to the buses in a multi-drop configuration. Other designs include point-to-point signaling. Bidirectional signaling may be sequential or simultaneous.

A port is an interface to a chip and includes associated transmitters and/or receivers. A multi-ported memory has more than one data port. For example, in some implementations of a multi-port memory, one port may be used for only reading data while another port may be used for reading and writing data. For example, in a Video DRAM (VRAM) one port is used like a typical DRAM port and can be used for reading and writing. The second port is used only for reading.

Different ports may have a different width (number of conductors or lanes). The concept of having a variable interconnect width is known.

Memory modules include a substrate on which a number of memory chips are placed. The memory chips may be placed on only one side of the substrate or on both sides of the substrate. In some systems, a buffer is also placed on the substrate. For at least some signals, the buffer interfaces between the memory controller (or another buffer) and the memory chips on the module. In such a buffered system, the memory controller can use different signaling (for example, frequency and voltage values, and point-to-point versus a multi-drop arrangement) with the buffer than the buffer uses with the memory chips. A dual in-line memory module (DIMM) is an example of a memory module. Multiple modules may be in series and/or parallel. In some memory systems, a memory chip receives signals and repeats them to a next memory chip in a series of two or more memory chips.

Memory controllers have been used in chipset hubs and in a chip that includes a processor core.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 is a block diagram representation of a system including a chip having a memory controller and a memory chip having first and second data ports according to some embodiments of the inventions.

FIG. 2 is a block diagram representation illustrating additional details of FIG. 1 according to some embodiments of the inventions.

FIG. 3 is a block diagram representation of a system including a chip having a memory controller and a memory chip having first, second, and third data ports according to some embodiments of the inventions.

FIG. 4 is a block diagram representation of a system including a chip having a memory controller, a chip with configuration selection circuitry, and a memory chip having first and second ports according to some embodiments of the inventions.

FIG. 5 is a block diagram representation of a system including a chip having a memory controller and two memory chips according to some embodiments of the inventions.

FIG. 6 is a block diagram representation of a system with a chip including a memory controller and first and second memory modules each including memory chips according to some embodiments of the inventions.

FIGS. 7 and 8 are each a block diagram representation of a system including a memory controller used in some embodiments of the inventions.

### DETAILED DESCRIPTION

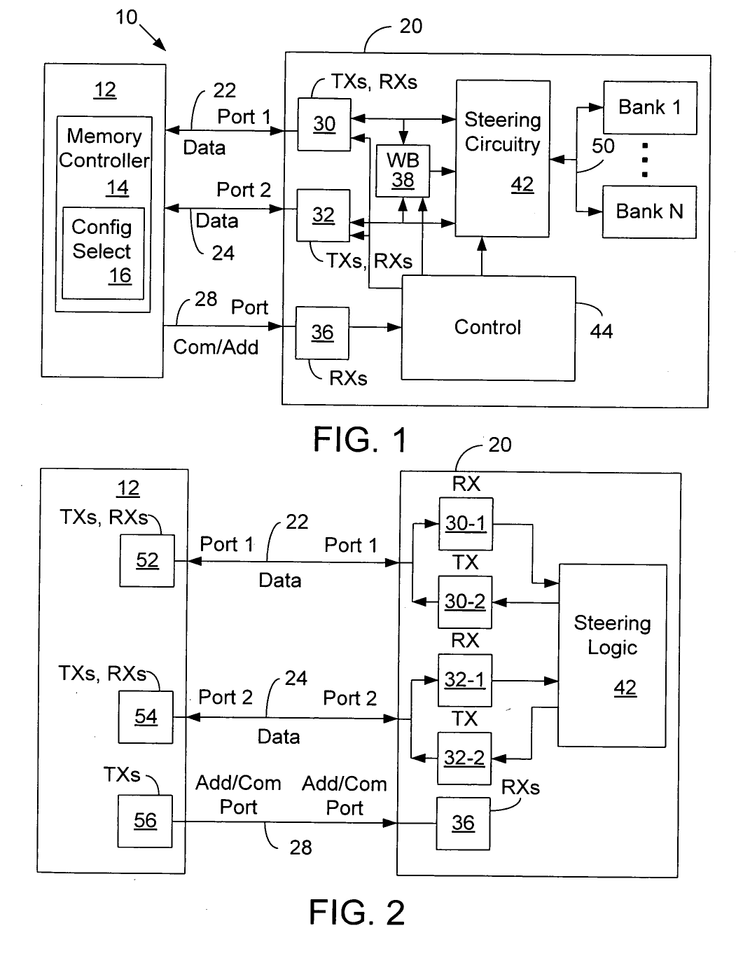

Referring to FIG. 1, a system 10 includes a chip 12 and a memory chip 20. Chip 12 includes a memory controller 14, which includes configuration selection circuitry 16. Data is communicated between chip 12 and memory chip 20 through interconnect 22, which is coupled to a data port 1. Data is also communicated between chip 12 and memory chip 20 through interconnect 24, which is coupled to a data port 2. Port 1 includes transmitters and receivers 30 and port 2 includes transmitters and receivers 32. In FIG. 1, interconnects 22 and 24 are shown as being bi-directional. However, in some configurations described below, they may be either unidirectional or bidirectional (sequential or simultaneous).

A write buffer 38 receives write data from at least one of ports 1 and 2 and provides them to steering circuitry 42. Steering circuitry 42 interfaces between ports 1 and 2 and memory banks 1 . . . N through interconnect 50. Interconnect 50 may be multi-drop or point-to-point. Steering circuitry 42 provides read data from the memory banks to at least one of the ports 1 and 2 and provides write data from at least one of ports 1 and 2 through write buffer 38 to the memory banks.

Command and address signals are provided from chip 12 through interconnect 28 to a port in chip 20 that includes receivers 36. Control circuitry 44 receives the commands from receivers 36. Configuration selection circuitry 16 selects a configuration for memory chip 20 and indicates that configuration to memory chip 20 through a configuration command to control circuitry 44. In some embodiments, the configuration command may also indicate one or more other things. That is, a single command may instruct memory chip 20 to do more than one thing, one of which is to have a particular configuration. Nevertheless, for convenience, this will be referred to as a configuration command, even though it might or might not also instruct memory chip 20 to do one or more other things. In some embodiments, the configuration command may be part of a packet that may include other information (such as address information) and perhaps other commands.

There is a configuration for data port 1, a configuration for data port 2, and a more general chip configuration which includes the configurations of data ports 1 and 2 and a configuration for steering circuitry 42, because the ports that steering circuitry 42 provides data is different in different configurations.

In some embodiments, the configuration command merely specifies a chip configuration and control circuitry 44 then responds to the configuration command by configuring ports 1 and 2 and steering circuitry 42. In other embodiments, the configuration command specifies the individual configurations of ports 1 and 2 and steering circuitry 42. In some embodiments, write buffer 38 is also configured by control circuitry 44.

Examples of data port configurations include whether the data port (1) may only be used for read transactions, (2) may only be used for write transactions, or (3) may be used for either read or write transactions while in the configuration. For some embodiments, all three configurations are available for each port. In other embodiments, only two of the three configurations are available for at least one of the data ports.

Table 1 provides possible configurations for some embodiments of memory 20 in FIG. 1. However, not all embodiments of memory 20 are required to do all three chip configurations and some embodiments have additional configurations.

TABLE 1

| Chip | Port 1 | Port 2 |
|---|---|---|
| Config No. | Config | Config |
| 1 | Read/Write | Read/Write |
| 2 | Read | Write |
| 3 | Read | Read/Write |

In chip configuration 1, ports 1 and 2 are both configured to be able to either read or write as directed by control circuitry 44. That is, while in chip configuration 1, port 1 and port 2 each may be used in read or write transactions. Both ports 1 and 2 may be used for read transactions at the same time, write transactions at the same time, or one port is used for a read transaction, while the other port is used for a write transaction. However, in other embodiments, ports 1 and 2 are not used both used for write transactions at the same time.

As an example of configuration 1, in FIG. 1, configuration selection circuitry 16 selects chip configuration 1 and chip 12 sends a corresponding configuration command on command/address interconnect 28 which is received by control circuitry 44 through receivers 36. In response to the command, control circuitry 44 controls the configuration of port 1 (transmitters and receivers 30), port 2 (transmitters and receivers 32), and steering circuitry 42 to be in configuration 1, which means that port 1 may perform either read or write transactions and port 2 may perform either read or write transactions.

In chip configuration 1, whether port 1 is used for reading or writing and whether port 2 is used for reading or writing for any particular transaction is decided by control circuitry 44 based on an algorithm that is also followed by memory controller 14 in chip 12. Various algorithms may be used. For example, the algorithm may be designed to meet read and write bandwidth and/or latency needs. If there is a lot of reading to be done, then both ports can be used for reading. If there is a lot of writing to be done, then both ports can be used for writing. If there is a roughly even mixture of reading and writing to be done, then one port may be used for reading, while the other is used for writing. For example, a cache line may be read across two ports to improve performance (for example, latency and/or bandwidth). In some embodiments, a transaction must be completed before a port switches between reading or writing. In other embodiments, a transaction could be partially competed when a port switches between reading and writing. Whether a particular port is used for reading or writing may change often or not very often during configuration 1. In some embodiments, ports 1 and 2 and steering circuitry 42 stay in a configuration until chip 12 sends another configuration command to change the configuration. In other embodiments, other signals, such as reset signals, can change the configuration.

In chip configuration 2, in response to receiving a configuration command, control circuitry 44 controls the configuration of one port (port 1 in Table 1) to be used only for read transactions and the other port (port 2 in Table 1) to be used only for write transactions. Configuration 2 may be thought of as a subset of configuration 1. An advantage of configuration 2 is the elimination of turnaround bubbles (time for a port to switch between reads and writes). Chip 20 may stay in configuration 2 until another configuration command is received.

In chip configuration 3, in response to receiving a configuration command, control circuitry 44 controls the configuration of one port (port 1 in Table 1) to be used only for read transactions and the other port (port 2 in Table 1) to be used for either read or write transactions. Whether port 2 is used for reading or writing for any particular transaction is decided by control circuitry 44 based on an algorithm that is also followed by memory controller 14 in chip 12. Chip 20 may stay in configuration 3 until another configuration command is received.

The configurations of the ports may change dynamically or “on the fly” as new configuration commands are received. Changing configurations can allow better use of data ports for bandwidth and/or latency needs. As can be seen in table 1, changing between chip configurations does not necessarily mean changing whether a particular port is used only for reading, only for writing, or for both. Accordingly, when control circuitry 44 controls a configuration of a particular data port, it does not necessarily mean that control circuitry 44 changes the configuration. If the configuration of the port is already correct, it can remain the same. If the configuration is not correct for a new configuration command, then the configuration is changed under the control of control circuitry 44.

In some embodiments, all data ports are configurable. In other embodiments (different than those described in connection with Table 1), at least one data port is not configurable, meaning it keeps the same configuration regardless of the configuration command. For example, as an alternative to the examples of Table 1, in system 10, data port 2 is always read/write regardless of the configuration, and data port 1 is changed in response to different configuration commands. As another alternative example, data port 2 is always “read only” regardless of a configuration command and data port 1 changes with the configuration command. Of course, data port 1 might remain constant while data port 2 changes.

FIG. 2 illustrates additional details for some embodiments of FIG. 1, but not all embodiments are required to include these details. In FIG. 2, transmitters and receivers 30 includes receivers 30-1 and transmitters 30-2. Transmitters and receivers 32 includes receivers 32-1 and transmitters 32-2.

FIG. 2 also illustrates that chip 12 includes ports that correspond to those in chip 20. For example, chip 12 includes a data port 1 that is coupled to data port 1 of chip 20 through interconnect 22, a data port 2 that is coupled to data port 2 of chip 20 through interconnect 24, and an address/command port that is coupled to the address/command port in chip 20 through interconnect 28. Data port 1, data port 2, and the address/command port in chip 12 include transmitters and receivers 52, transmitters and receivers 54, and transmitters 56, respectively. Chip 12 may also configure its own ports 1 and 2 to match the configuration in chip 20. However, the corresponding ports in chips 12 and 20 perform opposite types of transactions. For example, if data port 1 in chip 20 is used for transmitting, then data port 1 in chip 12 is used for receiving and vice versa.

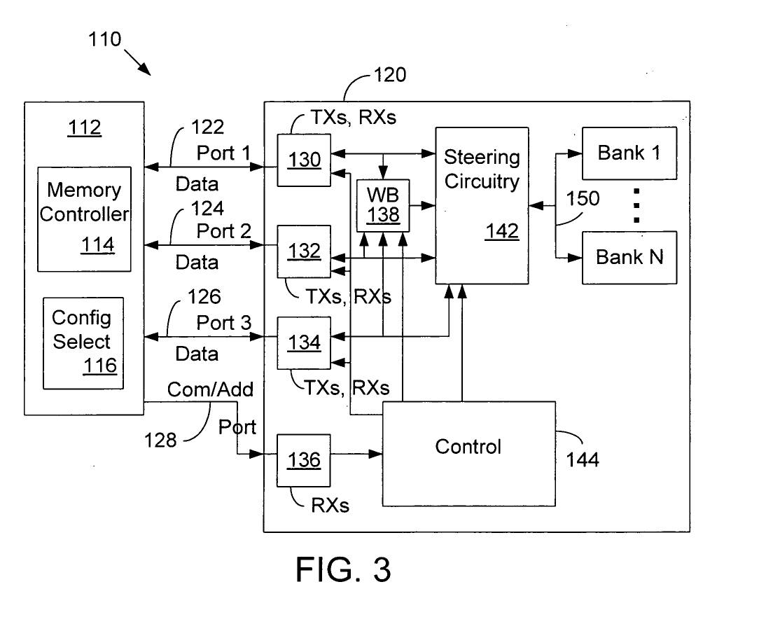

FIG. 3 illustrates a system 110 which is similar to the system 10 of FIG. 1. However, system 110 includes three data ports 1, 2, and 3 instead of two. Chip 112 includes a memory controller 114 and a configuration selection circuitry 116. Configuration selection circuitry 116 could have been part of memory controller 114 (and configuration selection circuitry 16 could have been separate from memory controller 14 in FIG. 1.) Data is communicated between chip 112 and memory chip 120 through interconnects 122, 124, and 126, which are coupled to ports 1, 2, and 3, respectively. Ports 1, 2, and 3 include transmitters and receivers circuitry 130, 132, and 134, respectively. Command and address signals are provided from chip 112 through an interconnect 128 to a port (including receivers 136) in chip 120. Configuration selection circuitry 116 selects a configuration for memory chip 120 by a configuration command to control circuitry 144 through receivers 136. Control circuitry 144 controls the configuration of port 1 (transmitters and receivers 130), port 2 (transmitters and receivers 132), port 3 (transmitters and receivers 134), and steering circuitry 142. A write buffer 138 receives write data from at least one of ports 1, 2, and 3 and provides them to steering circuitry 142. Steering circuitry 142 interfaces between ports 1, 2, and 3 and banks 1 . . . N through interconnect 150.

Table 2 shows four of the possible configurations that may be used in some embodiments of system 110. Other embodiments of system 110 do not allow all of these configurations and/or include additional configurations.

TABLE 2

| Chip | Port 1 | Port 2 | Port 3 |
|---|---|---|---|
| Config No. | Config | Config | Config |
| 1 | Read/Write | Read/Write | Read/Write |
| 2 | Read | Write | Read |
| 3 | Read | Read/Write | Read/Write |
| 4 | Read | Write | Read/Write |

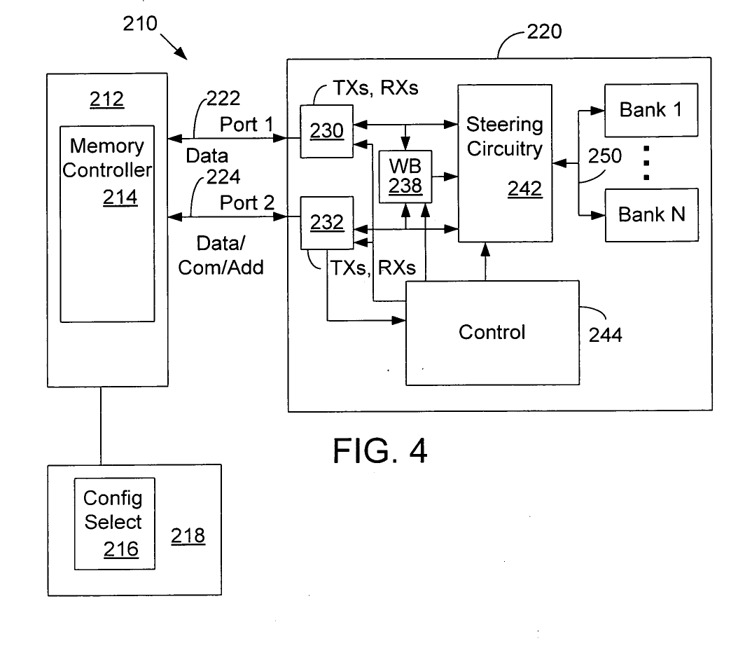

FIG. 4 illustrates a system 210, which is similar to system 10. However, port 2 is used for both data and command/addresses signals. The configurations for data in chip 220 can be the same as for chip 20. Referring to FIG. 4, chip 212 includes a memory controller 214. A chip 218 includes configuration selection circuitry 216. As an example, chip 218 may be a processor chip and the configuration selection circuitry 216 may be a processor core. An operating system or other software may decide the configuration. Systems 10 and 110 (FIGS. 1 and 3) may be modified to have the configuration selection circuitry as in system 210, and system 210 may be modified to have configuration selection circuitry as in system 10 or 110.

Data is communicated between chip 212 and memory chip 220 through interconnects 222, which is coupled to a data port 1. Chip 220 receives commands and addresses from chip 212 through interconnect 224 and port 2. Port 2 may also be used for reading and/or writing data between chips 212 and 220 depending on the configuration. Port 2 is called a data port even though it receives address and command signals. Port 1 includes transmitters and receivers 230 and port 2 includes transmitters and receivers 232.

Configuration selection circuitry 216 selects a configuration for memory chip 220. This configuration is indicated to memory chip 220 by a configuration command through port 2. In response to the command, control circuitry 244 controls the configuration of port 1 (transmitters and receivers 230), port 2 (transmitters and receivers 232), and steering circuitry 242. A write buffer 238 receives write data from at least one of ports 1 and 2 and provides them to steering circuitry 242. Steering circuitry 242 interfaces between ports 1 and 2 and banks 1 . . . N through interconnect 250. In some embodiments, a system like system 210 has one or more additional data ports in memory chip 220.

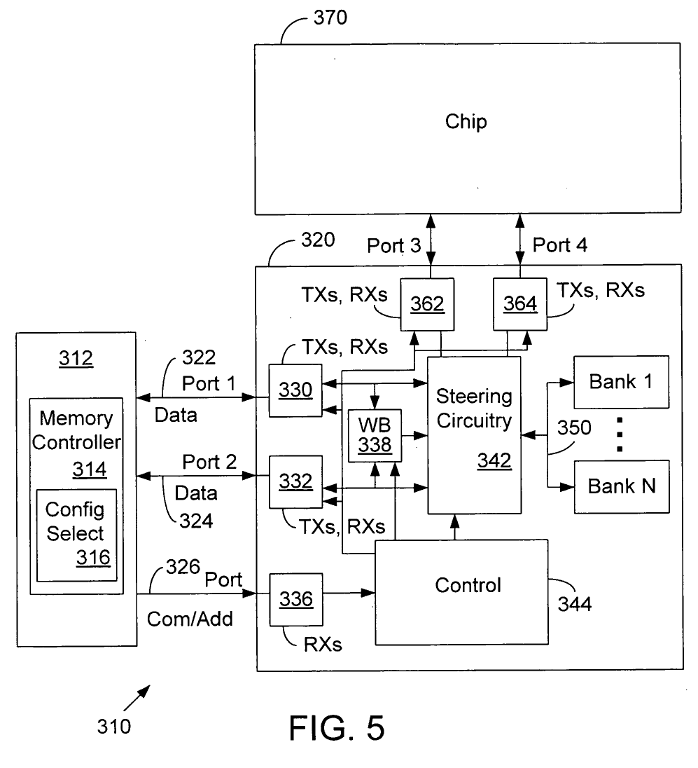

FIG. 5 illustrates that the memory chip may be coupled to another memory chip through configurable ports. A system 310 includes a chip 312 and memory chips 320 and 370. Chip 312 includes a memory controller 314, which includes configuration selection circuitry 316. Data is communicated between chip 312 and memory chip 320 through interconnect 322, which is coupled to a port 1. Data is also communicated between chip 312 and memory chip 320 through interconnect 324, which is coupled to a port 2. Port 1 includes transmitters and receivers 330 and port 2 includes transmitters and receivers 332.

Command and address signals are provided from chip 312 through interconnect 326 to a port in chip 320 that includes receivers 336. Configuration selection circuitry 316 selects a configuration for memory chip 320 and indicates that configuration to memory chip 320 by a configuration command to control circuitry 344 through receivers 336. Control circuitry 344 controls the configuration of port 1 (transmitters and receivers 330), port 2 (transmitters and receivers 332), and steering circuitry 342. A write buffer 338 receives write data from at least one of ports 1 and 2 and provides them to steering circuitry 342. Steering circuitry 342 interfaces between ports 1 and 2 and banks 1 . . . N through interconnect 350.

FIG. 5 includes a port 3 (including transmitters and receivers 362) and a port 4 (including transmitters and receivers 364). Chip 320 is coupled to chip 370 through port 3 and port 4. Data is communicated between chips 320 and 370 through port 3 and/or port 4. There may also be a port to communicate commands and addresses from chip 320 to 370. Configurations similar to those for ports 1 and 2, may also be used for ports 3 and 4. Command and address signals may be provide separately to chip 370 rather than through chip 320.

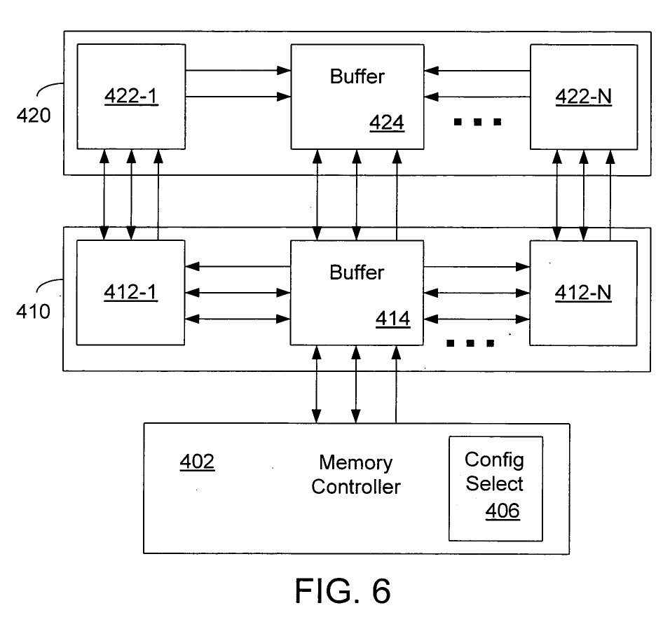

FIG. 6 illustrates a memory controller 402 with configuration selection circuitry 406. A memory module 410 includes a buffer 414 coupled to memory chips 412-1 . . . 412-N. A memory module 420 includes a buffer 424 coupled to memory chips 422-1 . . . 422-N. Buffers 414 and 424 may pass on configuration commands. There are various ways in which memory controller 402, buffers 414 and 424, and memory chips 412-1 . . . 412-N and 422-1 . . . 422-N may be interconnected. FIG. 6 illustrates only some ways and is not intended to illustrate all ways. For example, in some embodiments, chips 412-1 and 412-N are not coupled through interconnects to chips 422-1 and 422-N, respectively. Memory controller 402 may be like one of the controllers in FIGS. 1-5 or could be different. Memory chips 412-1 . . . 412-N and 422-1 . . . 422-N could be like one of the memory chips in FIGS. 1-5 or could be different.

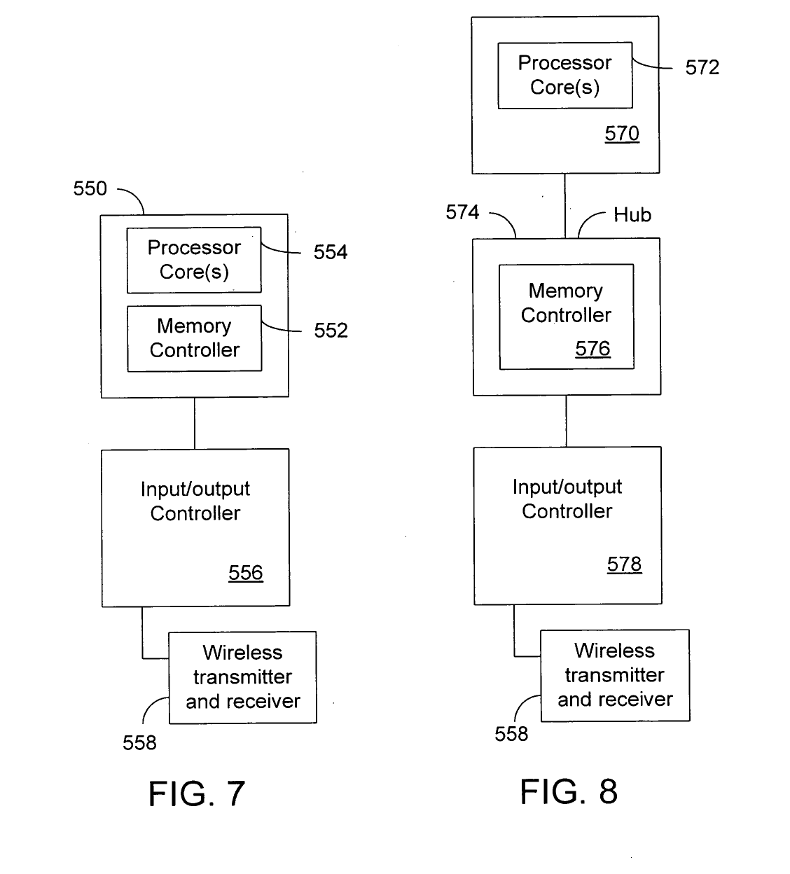

FIGS. 7 and 8 illustrate that the memory controller of FIGS. 1-6 could be in different types of chips. In FIG. 7, memory controller 552 is in a chip 550, which also includes at least one processor core 554. Chip 550 is coupled to an input/output controller 556, which in turn is coupled to wireless transmitter and receiver circuitry 558. In FIG. 8, memory controller 576 is in a chip 574, which is a hub between a chip 570 (including at least one processor core 572) and an input/output controller chip 578. Chip 578 is coupled to wireless transmitter and receiver circuitry 558. Other systems could be used. The configuration selection circuitry may be in various chips such as chips 550, 570, and 574.

Additional Information and Embodiments

Banks 1-N may be the same in each of the systems or different. Interconnects 50, 150, 250, and 350 may be the same in each of the systems or different. The transmitters and receivers may be the same in each of the figures or different. In the embodiments described above, banks 1-N are used for all the configurations. Alternatively, in other embodiments, there may be at least one bank that is not used in at least one configuration.

The different interconnects may have the same or different widths (that is, number of parallel conductors or lanes). For example, interconnects 22 and 24 may have the same width or different widths. Interconnects 22 and 24 may have the same width as interconnect 28 or have a different width. Interconnects 122, 124, and 126 may have different widths than interconnects 22 and 24. Merely as an example, a port that is used for reading might be 4 bits wide and a port used for writing might be 2 bits wide, but other widths may be used. In some embodiments, at least some of the widths are variable and controlled by control circuitry.

The inventions are not restricted to any particular signaling techniques or protocols. For example, the signaling may be single ended or differential. The signaling may include only two voltage levels or more than two voltage levels. A clock (or strobe) signal may be transmitted separately from the signals or embedded in the signals. Various coding techniques may be used. The inventions are not restricted to a particular type of transmitters and receivers. Various clocking techniques could be used in the transmitters and receivers and other circuits. The receiver symbols in the figures may include both the initial receiving circuits and related latching and clocking circuits. The interconnects between chips each could be point-to-point or each could be in a multi-drop arrangement, or some could be point-to-point while others are a multi-drop arrangement.

In the figures showing one or more modules, there may be one or more additional modules in parallel and/or in series with the shown modules.

In actual implementations of the systems of the figures, there would be additional circuitry, control lines, and perhaps interconnects which are not illustrated. When the figures show two blocks connected through conductors, there may be intermediate circuitry that is not illustrated. The shape and relative sizes of the blocks is not intended to relate to actual shapes and relative sizes.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments.

When it is said the element “A” is coupled to element “B,” element A may be directly coupled to element B or be indirectly coupled through, for example, element C.

When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.”

If the specification states a component, feature, structure, process, or characteristic “may”, “might”, or “could” be included, that particular component, feature, structure, process, or characteristic is not required to be included. If the specification or claim refers to “a” or “an” element, that does not mean there is only one of the element.

The inventions are not restricted to the particular details described herein. Indeed, many other variations of the foregoing description and drawings may be made within the scope of the present inventions. Accordingly, it is the following claims including any amendments thereto that define the scope of the inventions.

What is claimed is:

1. A chip comprising:
memory banks;
data ports, including at least first and second data ports, coupled to the memory banks; and
control circuitry to control a configuration of the first data port to be in one of multiple configurations in response to a configuration command, wherein the available configurations for the first data port include at least two of the following: whether the first data port (1) may only be used for read transactions, (2) may only be used for write transactions, or (3) may be used for either read or write transactions while in the configuration.

2. The chip of claim 1, wherein the control circuitry is also to control a configuration of the second data port to be in one of the multiple configurations in response to the configuration command, wherein the available configurations for the second data port include at least two of the following: whether the second data port (1) may only be used for read transactions, (2) may only be used for write transactions, or (3) may be used for either read or write transactions while in the configuration.

3. The chip of claim 2, wherein in response to at least one configuration command, the first data port is configured to be used only for read transactions and the second data port is configured to be used only for write transactions.

4. The chip of claim 2, wherein in response to at least one configuration command, none of the data ports are configured to be used only for write transactions.

5. The chip of claim 2, wherein the first and second data ports each include transmitters and receivers, and in response to at least one of the configuration commands, the receivers of the first data port and the transmitters of the second data port are inoperative.

6. The chip of claim 2, wherein the data ports further include a third data port.

7. The chip of claim 2, wherein the second data port also receives command and address signals and wherein the command signals include the configuration commands which are provided from the second data port to the control circuitry.

8. The chip of claim 2, wherein the configurations of the first and second data ports change dynamically in response to the control circuitry receiving additional configuration commands.

9. The chip of claim 1, further comprising an additional port for receiving command and address signals and wherein the command signals include the configuration command which are provided from the receivers to the control circuitry.

10. The chip of claim 1, further comprising steering circuitry to provide write data from at least one of the data ports to the memory banks and to provide read data from the memory banks to at least one of the data ports.

11. The chip of claim 10 wherein the control circuitry also controls the configuration of the steering circuitry.

12. A chip comprising:
data ports including at least first and second data ports; and
a memory controller including configuration selection circuitry to select configurations for the first data port and a data port in a remote memory chip, wherein the available configurations for the first data port and the remote data port each include at least two of the following: whether the first data port and the remote data port (1) may only be used for read transactions, (2) may only be used for write transactions, or (3) may be used for either read or write transactions while in the configuration.

13. The chip of claim 12, wherein if the configuration for one of the first data port is (1), then the configuration for the remote data port is (2), and if the configuration for the first data port is (3), then the configuration for remote data port is also (3).

14. The chip of claim 12, wherein the configuration selection circuitry further is to select configurations for the second data port in the chip and a second data port in the remote memory chip.

15. The chip of claim 12, further including an address/command port and wherein the chip provides configuration commands through the address/command port, and wherein the configuration commands indicate the configurations to be used by the other chip.

16. The chip of claim 12, wherein the chip includes at least one processor core.

17. A system comprising:
a first chip including a memory controller;
a memory chip coupled to the first chip through interconnects, the memory chip comprising:
memory banks;
data ports coupled to the interconnects and the memory banks, the data ports including at least first and second data ports; and
control circuitry to control a configuration of the first data port to be in one of multiple configurations in response to a configuration command, wherein the available configurations for the first data port include at least two of the following: whether the first data port (1) may only be used for read transactions, (2) may only be used for write transactions, or (3) may be used for either read or write transactions while in the configuration.

18. The system of claim 1, wherein the control circuitry is also to control a configuration of the second data port to be in one of the multiple configurations in response to the configuration command, wherein the available configurations for the second data port include at least two of the following: whether the second data port (1) may only be used for read transactions, (2) may only be used for write transactions, or (3) may be used for either read or write transactions while in the configuration.

19. The system of claim 17, further comprising additional memory chips coupled to the first chip.

20. The system of claim 17, wherein the memory chip is one of several memory chips on a memory module.

21. The system of claim 20, further comprising a buffer chip on the memory module and wherein the memory chip is coupled to the first chip through the buffer chip.

22. The system of claim 17, further comprising a wireless transmitter and receiver coupled to the first chip.

23. The system of claim 17, wherein the first chip includes at least one processor core.

24. A method comprising:
selecting configurations for data ports; and
providing a configuration command indicating the configurations, wherein the configurations involve at least two of the following: whether the data ports (1) may only be used for read transactions, (2) may only be used for write transactions, or (3) may be used for either read or write transactions while in the configuration.

25. The method of claim 24, further comprising:
receiving the configuration command and in response there to controlling the configuration of the data ports as indicated.

26. The method of claim 24, further comprising changing the configurations through providing a new configuration command.
